(19) United States
(12) Patent Application Publication
(10) Pub. No.: US 2004/0144271 A1
(43) Pub. Date: Jul. 29, 2004

(54) Printing machine with several sections

(76) Inventor: Burkhard Otto Herbert, Wurzburg (DE)

Correspondence Address: Douglas R Hanscom, Jones Tullar & Cooper, Eads Station, PO Box 2266, Arlington, VA, 22202, US

(21) Appl. No.: 10/481,409

(22) PCT Filed: Jun. 6, 2002
(86) PCT No.: PCT/DE02/02055

(30) Foreign Application Priority Data
Jul. 2, 2001 (DE) 101 31 976.2

(51) Int. Cl. B41F 13/54

(52) U.S. Cl. 101/219

(57) ABSTRACT

A printing machine includes several sections, each of which has at least one printing unit with at least one web running through the at least one printing unit per section. Two such sections are arranged offset to each other, transverse to the longitudinal direction of the printing machine. Production of a printed product is achieved, at least in part, by using a common folding unit that extends over the total width of the printing machine.

The invention relates to a printing press with several sections in accordance with the preamble of claim 1 or 4.

A printing press is known from DE 197 28 207 A1, wherein webs from two sections which are in alignment with each other are conducted into two turning towers arranged between them, undergo a change of direction and are possibly laterally offset.

DE 42 04 254 A1 discloses a folding structure with formers which can be displaced transversely in relation to the running direction of the webs. This allows the longitudinal folding of partial webs which, because of being cut longitudinally, can have changing widths, or the longitudinal folding of paper webs of different total widths.

Two printing presses arranged parallel with each other and each having an assigned folding structure are known from EP 0 627 312 A2. In one mode of operation the imprinted webs can be combined and conducted to one of the two side-by-side arranged folding structures.

The employment of a folding structure with three formers arranged side-by-side and respectively two arranged on top of each other is known from U.S. Pat. No. 3,942,782, wherein the webs to be folded arrive from two sections arranged aligned with each other, each of triple width, and enter the common triple width folding structure.

DE 199 58 089 A1 discloses two printing presses which, for space savings, are arranged horizontally and vertically side-by-side. In one embodiment a common folding apparatus can be assigned to the two printing presses.

DE 195 16 445 A1 discloses a printing press with two sections which are offset in the longitudinal direction in relation to each other, wherein a common folding structure is arranged only between the sections which extend parallel with each other.

The invention is based on the object of providing a printing press with several sections.

This object is attained in accordance with the invention by means of the characteristics of claim 1 or 4.

The advantages to be achieved by means of the invention lie in particular in the high degree of dependability and efficiency in the passage of the web through the printing press, along with simultaneously a great flexibility of products which can be made.

In regard to a dependable and efficient web guidance it is particularly advantageous if as many webs as possible run straight, i.e. without turning or lateral offset, through the printing press into the associated former.

In a solution in accordance with a first exemplary embodiment, several offset, narrower, for example single-width printing units or sections used instead of one wide one, it is for example possible to achieve the productivity of a double-width printing press and a high degree of flexibility regarding the usability of different formats of imprinted materials, for example paper formats, without an elaborate and disadvantageous for the running of the imprinted material, offset of the web or an offset of the formes because of a change from one imprinted material format to another imprinted material format being required. A possibly increased investment outlay is in contrast to a reduced outlay for retooling and a reduced danger potential in case of a web break, and/or losses in quality.

In connection with a multi-web operation of the sections, the embodiment of the folding structure with balloon formers and with variable strand guidance to the folding unit is of particular advantage in view of product variety. If the strands can be combined on two folding apparatus, the variety of the products which can be made is further increased.

The offset arrangement of two double-width sections in accordance with a second exemplary embodiment makes possible the productivity of two double-width sections arranged in alignment, along with a simultaneously high product variety. In contrast to double-width sections arranged in alignment, it is not necessary here to guide a complete strand of webs laterally out of the profile of the printing press. If it is intended to produce books or strands of more or less the same thickness, most of the partial webs can be conducted straight ahead and centered toward the former while, for example, only a few partial webs, for example two partial webs per section, must be turned out of the center strand onto one of the outer strands.

A high degree of flexibility in regard to product variety, a high printing output, i.e. productivity, along with simultaneously a high dependability in the course of the webs, are achieved by means of the offset of the sections.

Exemplary embodiments of the invention are represented in the drawings and will be described in greater detail in what follows.

Shown are in:

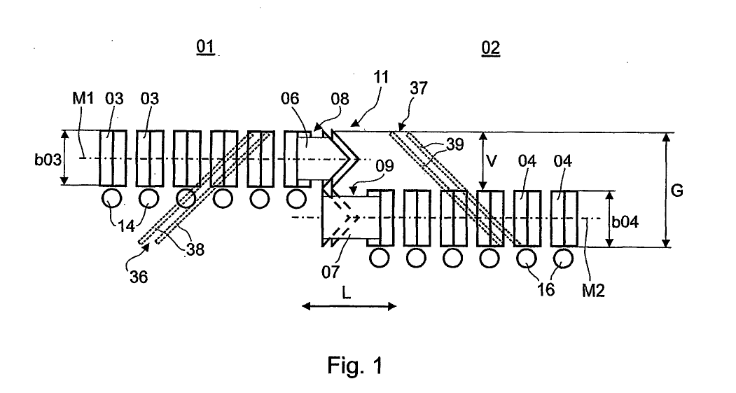

FIG. 1, a schematic representation in a view from above on a first exemplary embodiment,

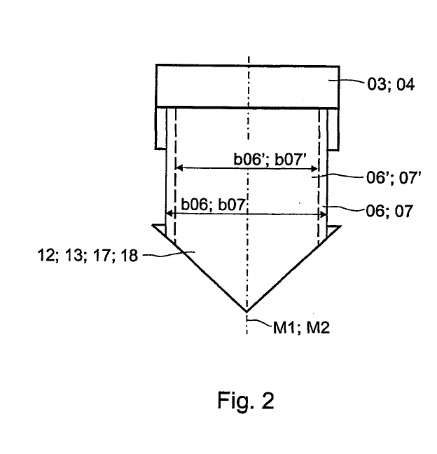

FIG. 2, a schematic representation of a web entering a folding structure,

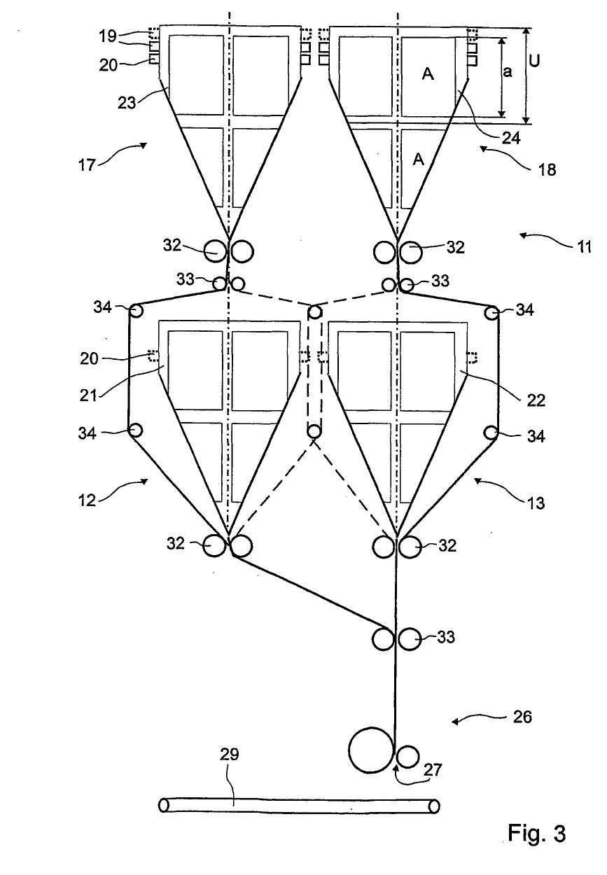

FIG. 3, a first exemplary embodiment of a folding structure and a folding unit in accordance with the first exemplary embodiment in FIG. 1,

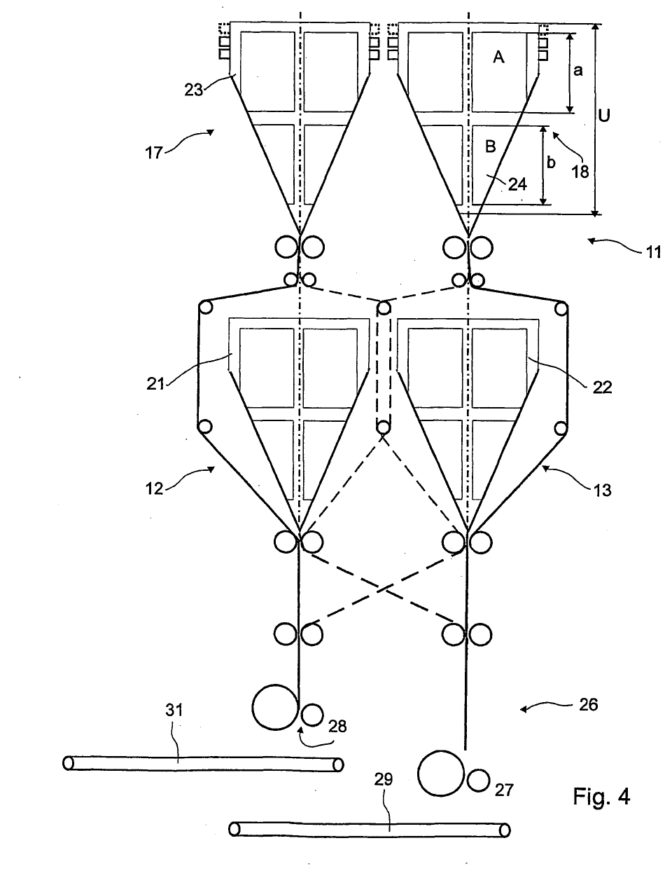

FIG. 4, a second exemplary embodiment of a folding structure and a folding unit in accordance with the first exemplary embodiment in FIG. 1,

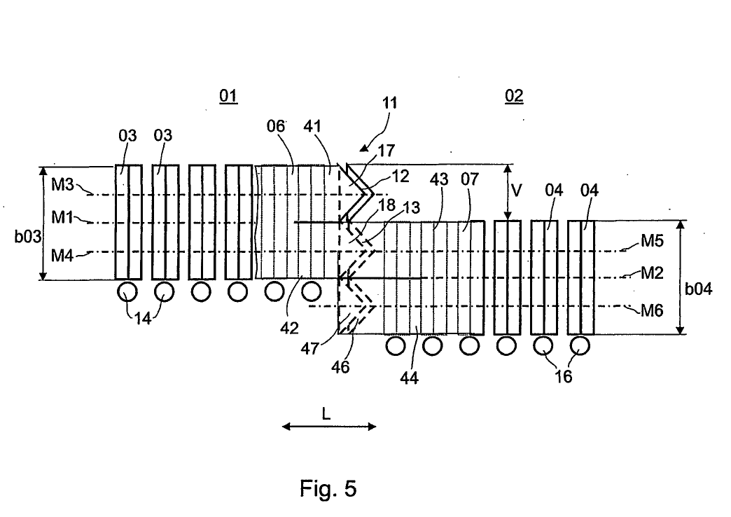

FIG. 5, a schematic representation in a view from above on a second exemplary embodiment.

A printing press, in particular a web-fed rotary printing press, has at least two sections 01, 02, each with at least one printing unit 03, 04, through which pass webs 06, 07 (for the sake of clarity only one web 06, 07 per section 01, 02 is represented), for example webs of material 06, 07 to be imprinted.

Each of the printing units 03, 04 of each section 01, 02 is arranged aligned side-by-side and can be arranged on top of each other and/or behind each other. In the exemplary embodiments represented in FIG. 1 and FIG. 5, the printing units 03, 04 of each section 01, 02 are aligned horizontally behind each other, so that the center vertical lines of the printing units 03, 04 of the respective sections 01, 02 are each located in one plane M1, M2.

The sections 01, 02 are arranged with each other in such a way that their planes M1, M2 do not coincide. In an advantageous embodiment, the sections 01, 02 are arranged in such a way that the planes M1, M2 extend parallel, but transversely in respect to the longitudinal direction L of the printing press, i.e. offset from each other in an axial direction of the printing group cylinders. For example, in this case the printing units 03, 04 are arranged on the same horizontal plane, for example in one-level construction. The printing units 03, 04 can be bridge printing units, singly or stacked, H-printing units, singly or stacked, so-called towers of eight, individual or stacked nine- or ten-cylinder satellite printing units.

A folding structure 11 assigned to the two sections 01, 02 is arranged on at least one end 08, 09 in the longitudinal direction of each section 01, 02, which extends over at least a total width G of the sections 01, 02 arranged offset or side-by-side. In this case in particular an effective total width G is to be understood as the total width G, which is defined by each of the outside located edges of the effective widths b03, b04 usable for printing of the printing units 03, 04, or their printing group cylinders. The folding structure 11 has at least two formers 12, 13, of which at least one is arranged aligned with the plane M1 and M2, i.e. centered in respect to the sections 01, 02, or the printing units 03, 04.

As FIG. 2 schematically shows, is is thus possible to operate the printing press with different web widths, for example with webs 06, 07 of a width b06, b07, or webs 06′, 07′ of a width b06′, b07′. Each of the centers of the webs 06, 07, 06′, 07′ coincides with the plane M1, M2, and runs centered to the assigned former 12, 13, independent of the width b06, b07, b06′, b07′ of the webs 06, 07, 06′, 07′ and without a requirement of a lateral offset, or turning.

In the first exemplary embodiment in accordance with FIG. 1, each section 01, 02 has six printing units 03, 04 arranged one behind the other. The sections 01, 02 are offset in relation to the planes M1, M2, and in relation to a longitudinal direction L of the printing press they are arranged downstream of, or upstream of the folding structure 11.

In the example, a lateral offset V of the sections 01, 02 has at least an effective width b03, b04 of the printing units 03, 04, which is determined by the imprintable width of printing groups not represented in detail, or of their printing group cylinders, and which simultaneously corresponds to a maximum width b06, b07 of the web 06, 07. If the printing units 03, 04 of the sections 01, 02 have different effective widths b03, b04, or maximal widths b06, b07, the offset V should be selected to be at least as large as half the sum of b03 and b04, or b06 and b07.

If a product, for example a newspaper, is only longitudinally folded once prior to its delivery, the offset V of the two sections 01, 02 is preferably at least twice the product width, or at least the width of two printed pages A, B, in the axial direction of the printing group cylinders (FIGS. 3 and 4).

In an advantageous embodiment, the printing units 03, 04 are embodied with single width printing group cylinders, i.e. two printed image widths of printed pages A, such as for example newspaper pages A (see FIG. 3), in the longitudinal direction of the printing group cylinder. For manufacturing a product which is to be longitudinally folded prior to entering the folding structure 11, no longitudinal cut is thus required. This in turn makes possible the mentioned use of webs 06, 07, 06′, 07′ of different widths, each oriented centered in respect to the plane M1, M2 (FIG. 2), without having to offset the otherwise cut partial webs, or the formers 12, 13. In this case the folding structure 11 is embodied to be “double wide”, i.e. it has a width which at least corresponds now to the total of four printed pages of the two webs 06, 07 running in next to each other out of the sections 01, 02. In this way it is possible without any great outlay, and without worsening the running of the web 06, 07, to change between different product formats, for example newspaper formats such as the Rheinische, Berlin, New York Times newspaper formats, etc., i.e. different rolls 14, 16, for example rolls 14, 16 of material to be imprinted, for the web 06, 07.

In this case at least six rolls 14, 16 are assigned to the six printing units 03, 04 of each section 01, 02, from which the webs 06, 07 are unrolled and conducted through the printing press. The rolls 14, 16 can be arranged on the same plane or on one different from the printing units 03, 04, for example on a plane located underneath (in FIG. 1 symbolically next to the printing units 03, 04).

The webs 06 conducted from the rolls 14 of the section 01 through the printing units 03 can now be conducted during production, the same as the webs 07 conducted from the rolls 16 of the section 02, via rollers, not represented, with a straight run of the web “straight”, or “straight ahead” to the respectively assigned former 12 or 13 of the folding structure 11. With a symmetrical arrangement of the webs 06, 07 this is independent of the width b06, b07 of the webs 06, 07, provided that the effective width b03, b04 of the printing units 03, 04 is not exceeded.

With an increased number of possible webs 06, 07, such as is the case in the present exemplary embodiment with six printing units 03, 04 each, an embodiment of the folding structure 11 is advantageous, wherein a further former 17, 18, a so-called balloon former 17, 18, is assigned to each one of the formers 12, 13 arranged side-by-side. In a preferred embodiment, the folding structure 11 has two formers 12, 13, 17, 18 each side-by-side, and two formers 12, 17, 13, 18 each on top of each other.

The straight course of many unturned webs 06, 07, as well as a distribution as evenly as possible of the total of twelve webs 06, 07 on four formers 12, 13, 17, 18, for example, is advantageous in particular in view of dependable and interruption-free web running.

The webs 06, 07 are combined upstream of, or above the formers 12, 13, 17, 18, for example via wire-rod rollers 19 and former draw-in rollers 20, into strands 21, 22, 23, 24, and are longitudinally folded by means of the formers 12, 13, 17, 18 before they are conducted to a folding unit 26 with one or several folding apparatus 27, 28, are transversely cut there and, if required, are folded again or several times, and leave the printing press in the form of a product or intermediate product over one or several delivery devices 29, 31.

Depending on the number and capabilities of the associated folding apparatus 27, 28, depending on the strand guidance in the folding structure 11, and depending on the number of delivery devices 29, 31 in the folding unit 26, the strands 21, 22, 23, 24 can be processed into a multitude of different products or intermediate products.

In a first embodiment (FIG. 3) of the first exemplary embodiment (FIG. 1) of the folding structure 11 and the folding unit 18, the folding structure 11 has the wire-rod rollers 19 (sketched in) and the four formers 12, 13, 17, 18, and the folding unit 16 a single folding apparatus 27 (schematically), which deposits on a single delivery device 29.

For the purpose of arranging the strands 21, 22, 23, 24 in the sequence required for the product, the folding structure 11 has, inter alia, known folding rollers 32, traction rollers 33, as well as deflection rollers 34.

In the ideal case of the web run, namely webs 06, 07 which only run straight, and an even distribution of the twelve webs 06, 07 to the strands 21, 22, 23, 24, or to the formers 12, 13, 17, 18, each strand 21, 22, 23, 24 has three webs 06 or 07. If the printing units 03, 04 (as represented by way of example in FIG. 3 by the emerging printed image) are equipped with printing group cylinders of single circumference, i.e. a section length a of a printed page A, such as a newspaper page A, at the circumference U, and single width, i.e. two printed pages A on a web 06, 07, or a former 12, 13, 17, 18 side-by-side, a product with four books, each of twelve pages, can be produced by means of the printing press and the folding apparatus 27. However, it is also possible by means of the straight-running webs 06, 07 to produce books of different numbers of pages, in that the webs 06, 07 are combined into strands 21, 22, 23, 24 of different thickness in the formers 12, 17, 13, 18 respectively arranged on top of each other.

When designing the printing units with double circumference U (such as is represented by way of example by the emerging printed image in a second embodiment in FIG. 4), it is possible under the above mentioned conditions (straight run, even distribution, single width) to provide a product with maximally eight books, each with maximally twelve pages, if two section lengths a, b of two printed pages A, B, such as for example two newspaper pages A, B, are arranged on the printing group cylinders of double circumference U one behind the other in the circumferential direction, and the folding apparatus is embodied for collection operation.

FIG. 4 shows a second embodiment of the first exemplary embodiment (FIG. 1) of a folding structure 11 with a folding unit 16 wherein however, in contrast to FIG. 3, the folding unit 16 has two folding apparatus 27, 28 and two delivery devices 29, 31. This makes possible the production options in FIG. 3 in that the strands 21, 22, 23, 24 are brought together on one of the two folding apparatus 27, 28, and in this way a single product with a large number of pages is made.

In addition, however, it is also possible to create two different products with the same or different number of books and/or pages by means of distributing the strands 21, 22, 23, 24 on the two folding apparatus 27, 28 and to deposit them on the two delivery devices 29, 31. For achieving double the production speed, it is also possible to print the same product simultaneously, for example in section 1 and section 2, and to finish them parallel in the folding structure 11, as well as in the folding unit 16, and to deposit them.

To further increase flexibility, a turning deck 36, 37 with at least one pair of turning bars 38, 39 extending over the entire width G of the printing press (FIG. 1, dashed lines), and non-represented devices for length compensation, if required, is arranged in at least one of the sections 01, 02 in a further advantageous development of the invention.

Since the basic orientation of the printing press already provides an even distribution without turning and lateral offset, by means of turning only one web 06, 07 it is possible for the printing units 03, 04 of single circumference, or double circumference with double production, to increase one book by four pages and to reduce the other one by four pages. Double this applies for printing units 03, 04 of double circumference with collection production.

In order to further increase the options in the composition of books it can be advantageous to provide devices (not represented) for longitudinal cutting of the webs 06, 07 upstream of the formers 12, 17, 13, 18. In this way the books can be put together in steps of two pages (single circumference, or double production) or four pages (double circumference and collection production).

If its is intended to achieve greater flexibility in the graduation of the possible number of pages of the product, or the setup of the books without a need for equipping them twice with the same printing plates, and for collection, the embodiment of the printing units 03, 04, or their printing group cylinders, in particular the forme cylinders, with a single circumference U, as described above, is of advantage. When changing from one roll 14, 16 of full width b06, b07 (1/1), for example, of the web 06, 07 to a half (½) web 06, 07, etc., a graduation in two lateral steps (so-called “two page jump) is possible.

If the emphasis lies in the option for the simultaneous production of as many varied products as possible, printing units 03, 04 of double circumference, the arrangement of two folding apparatus 27, 28, possibly with sorters and four delivery devices 29, 31, is of advantage.

The numbers recited for the first exemplary embodiment apply by way of example for double-sided multi-color printing, for example by means of printing units 03, 04 embodied as towers of eight for four-color printing. If no such demand is made for multi-coloring, it is for example also possible in connection with a section 01, 02 with six webs 06, 07 to pass through only four printing units 03, 04 designed as printing towers 03, 04. In the same way it is also possible to embody one section 01, 02 for fewer or more webs 06, 07, in which case the number of printing units 03, 04, or printing towers 03, 04, per section 01, 02, depends on the requirement for colors and the number of webs 06, 07.

Divergent from the exemplary embodiment represented in FIG. 1 it is also possible, for example in connection with appropriate space conditions, to arrange the sections 01, 02 side-by-side, in which case the webs 06, 07 run from the same side into the common folding structure 11 extending over the entire width G.

In a second exemplary embodiment (FIG. 5), the printing units 03, 04 of the sections 01, 02, or their printing groups, are embodied with printing group cylinders of double width, i.e. four printed image widths, for example newspaper pages A, B, in the longitudinal direction of the printing group cylinder. The effective width b03, b04 therefore corresponds to at least four printed pages, or individual printing plates, placed side-by-side, or to two panorama printing plates.

The two sections 01, 02 are offset in respect to the planes of their center vertical lines M1, M2, and are arranged in respect to a longitudinal direction L of the printing press downstream or upstream of the folding structure 11, which is assigned to both sections 01, 02.

If the webs 06, 07, here of double widths, are longitudinally cut by devices, not represented, prior to their entry into the folding structure 11, such as is required, for example, for the production of newspapers, the planes of the central vertical lines M3, M4, M5, M6 of webs 41, 42, 43, 44, so-called partial webs 41, 42, 43, 44, or partial web strands formed from them, are of importance for as straight as possible an entry into the folding structure 11. For greater clarity only one double-width web 06, 07 is represented per section 01, 02, which is cut into respectively two partial webs 41, 42, 43, 44 by means of cutting devices, not represented.

The lateral offset V of the sections 01, 02 approximately corresponds to a width of one of the partial webs 42, 43, or to double the width of the finished product folded once longitudinally. In case of sections 01, 02, or webs 06, 07, of equal width, and with longitudinal cutting into two partial webs 41, 42, 43, 44 of equal width, the offset V corresponds to half the width b06, b07 of the original web 06, 07. Therefore the plane M4 coincides with the plane M5.

The common folding structure 11 is arranged between the sections 01, 02 and has at least three formers 12, 13, 46 arranged side-by-side. The folding structure 11 preferably has further three formers 17, 18, 47, for example in the form of balloon formers 17, 18, 47, which are also arranged side-by-side, but above the first formers 12, 13, 46. The formers 12, 13, 17, 18, 46, 47 are arranged aligned in respect to the planes M3, M4 (=M5) and M6, which allows a straight entry of the partial web strands 41, 42, 43, 44 into the folding structure 11.

The arrangement provides the productivity of a printing press of double width with two sections 01, 02 arranged aligned with each other, allows a product variety which, in the case of printing presses of double width arranged aligned, is achieved with a three-story folding structure and appropriate turning deck, or by the lateral offset and removal of all partial webs for a fifth, and possibly a sixth strand. The product variety approximately corresponds to that of a triple-width printing press with a triple-width folding structure.

As in the first exemplary embodiment (FIG. 1), the sections 01, 02 can have a turning deck 36, 37, not represented, in order to match the thickness of the individual partial strands 41, 42, 43, 44 to the requirements of the books to be produced. For example, for obtaining six identical book thicknesses when using six formers 12, 13, 17, 18, 46, 47, it is necessary, for example, to turn or offset merely two partial webs 42, 43, or an uncut web 06, 07, onto an outer partial web 41, 44, or an outer web 06, 07, per section 01, 02.

As in the first exemplary embodiment (FIG. 1), the webs 06, 07 are supplied from rolls 14, 16 to the sections 01, 02, and are conducted to the formers 12, 13, 17, 18, 46, 47 upstream of the folding structure 11 by means of wire-rod rollers, not represented. Product delivery can take place on one, on two, on three, or up to six non-represented formers having a corresponding number of also non-represented delivery devices. In this case the options of the production should then be applied in accordance with the principle in the first exemplary embodiment.

For an even greater number of producible books, or greater product thicknesses, or greater variability, it is also possible to arrange the two sections 01, 02 from FIG. 5 completely offset in respect to each other corresponding to FIG. 1. In this case a folding structure 11 is embodied with four formers 12, 13, 46 arranged side-by-side. In an advantageous embodiment, additional four further formers 17, 18, 46 are again arranged on top. The folding structure 11 extends over the effective total width G.

It is possible with this arrangement to simultaneously produce up to eight books in printing units 03, 04 with cylinders of single circumference, and in printing units 03, 04 with cylinders of double width and in collection production up to sixteen different books.

List of Reference Symbols

01 Section

02 Section

03 Printing unit, tower of eight, printing tower

04 Printing unit, tower of eight, printing tower

05 -

06 Web, web of material to be imprinted

07 Web, web of material to be imprinted

08 End (01)

09 End (02)

10 -

11 Folding structure (01, 02)

12 Former

13 Former

14 Roll, roll of material to be imprinted

15 -

16 Roll, roll of material to be imprinted

17 Former, balloon former

18 Former, balloon former

19 Wire-rod roller

20 Former draw-in roller

21 Strand

22 Strand

23 Strand

24 Strand

25 -

26 Folding unit

27 Folding apparatus

28 Folding apparatus

29 Delivery device

30 -

31 Delivery device

32 Folding roller

33 Traction roller

34 Deflection roller

35 -

36 Turning deck

37 Turning deck

38 Pair of turning bars

39 Pair of turning bars

40 -

41 Web, partial web

42 Web, partial web

43 Web, partial web

44 Web, partial web

45 -

46 Former

47 Former, balloon former

06′ Web

07′ Web

b03 Width (03)

b04 Width (04)

b06 Width (06)

b07 Width (07)

b06′ Width (06′)

b07′ Width (07′)

a Section length (A)

b Section length (B)

A Printed page, newspaper page

B Printed page, newspaper page

G Total width

L Longitudinal direction

U Circumference of a printing group or forme cylinder

V Offset (01, 02)

M1 Level of the center vertical line

M2 Level of the center vertical line

M3 Level of the center vertical line

M4 Level of the center vertical line

M5 Level of the center vertical line

M6 Level of the center vertical line

1. A printing press with several sections (01, 02), each of which has at least a printing unit (03, 04), through which at least one web (06, 07) passes, wherein the printing units (03, 04) of at least two sections (01, 02) produce at least partially on a folding structure (11) to be assigned to both sections (01, 02), and at least two of the at least two sections (01, 02) producing at least partially on the common folding structure (11) are arranged offset in respect to each other transversely to a longitudinal direction (L) of the printing press, characterized in that the folding structure (11) has a width which corresponds at least to an effective total width (G) of the sections (01, 02), which are arranged offset in respect to each other transversely to the longitudinal direction (L).

2. The printing press in accordance with claim 1, characterized in that the sections (01, 02) are arranged offset in respect to each other transversely to the longitudinal direction (L), as well as in the longitudinal direction (L).

3. The printing press in accordance with claim 1, characterized in that the sections (01, 02) are arranged next to each other.

4. A printing press with several sections (01, 02), each of which has at least a printing unit (03, 04), through which at least one web (06, 07) passes, wherein the printing units (03, 04) of at least two sections (01, 02) produce at least partially on a folding structure (11) to be assigned to both sections (01, 02) which, viewed in the longitudinal direction (L) of the printing press, is arranged between the two sections (01, 02) which at least partially produce on a common folding structure (11), characterized in that the two sections (01, 02) are arranged offset in respect to each other transversely in respect to a longitudinal direction (L) of the printing press.

5. The printing press in accordance with claim 4, characterized in that the folding structure (11) has a width which corresponds to at least an effective total width (G) of the sections (01, 02) which are arranged offset.

6. The printing press in accordance with claim 1 or 4, characterized in that an offset (V) transversely to the longitudinal direction (L) corresponds at least to twice the width of a product which has been longitudinally folded once.

7. The printing press in accordance with claim 1 or 4, characterized in that an offset (V) transversely to the longitudinal direction (L) corresponds at least to a width of a printed page (A, B) in the axial direction of the printing group cylinders.

8. The printing press in accordance with claim 1 or 4, characterized in that the printing units (03, 04) of the sectors (01, 02) are embodied at a single length, in particular for printing of respectively two printed pages (A, b) arranged axially side-by-side.

9. The printing press in accordance with claim 8, characterized in that the folding structure (11) is embodied double-wide, in particular for processing four printing pages (A, B) arranged axially side-by-side.

10. The printing press in accordance with claim 9, characterized in that the folding structure (11) has two formers (12, 13, 17, 18), which are arranged side-by-side transversely in respect to the longitudinal direction (L) of the printing press.

11. The printing press in accordance with claim 9, characterized in that the folding structure (11) has two formers (12, 13), which are arranged side-by-side transversely in respect to the longitudinal direction (L) of the printing press and two formers (17, 18) arranged above them.

12. The printing press in accordance with claim 10 or 11, characterized in that each former (12, 13, 17, 18) is arranged aligned in respect to a plane (M1, M2) of a center vertical line of the printing units (03, 04) constituting the sections (01, 02).

13. The printing press in accordance with claim 9, characterized in that a single folding apparatus (27) is assigned to the folding structure (11).

14. The printing press in accordance with claim 9, characterized in that at least two folding apparatus (27, 28) are assigned to the folding structure (11).

15. The printing press in accordance with claim 13 or 14, characterized in that at least one delivery device (29, 31) is assigned to each folding apparatus (27, 28).

16. The printing press in accordance with claim 2, characterized in that, viewed in the longitudinal direction (L) of the printing press, the folding structure (11) is arranged between the two sections (01, 02).

17. The printing press in accordance with claim 1 or 4, characterized in that the printing units (03, 04) of the sections (01, 02) are embodied to be double wide, in particular for printing respectively four printed pages (A, B) arranged axially side-by-side.

18. The printing press in accordance with claim 17, characterized in that the folding structure (11) is embodied triple-wide, in particular for processing six printed pages (A, B) arranged axially side-by-side.

19. The printing press in accordance with claim 17, characterized in that the folding structure (11) has three formers (12, 13, 17, 18, 46, 47) arranged side-by-side transversely to the longitudinal direction (L) of the printing press.

20. The printing press in accordance with claim 17, characterized in that the folding structure (11) has three formers (12, 13, 46) arranged side-by-side transversely to the longitudinal direction (L) of the printing press, and three formers (17, 18, 47) arranged above them.

21. The printing press in accordance with claim 1 or 4, characterized in that a turning deck (36, 37) is assigned to at least one of the sections (01, 02), which extends over the total width (G) of the offset arranged sections (01, 02).
